(19) United States
(12) Patent Application Publication
(10) Pub. No.: US 2025/0272335 A1
(43) Pub. Date: Aug. 28, 2025

(54) METHOD, APPARTUS, DEVICE AND STORAGE MEDIUM FOR MEDIA ITEM GENERATION

(71) Applicant: Beijing Zitiao Network Technology Co., Ltd., Beijing (CN)

(72) Inventors: Xu Liu, Beijing (CN); Xinyu Zhang, Beijing (CN)

(21) Appl. No.: 19/060,612

(22) Filed: Feb. 21, 2025

(30) Foreign Application Priority Data
Feb. 23, 2024 (CN) 202410204985.3

(51) Int. Cl. G06F 16/538

(52) U.S. Cl. CPC G06F 16/538

(57) ABSTRACT

Embodiment of the disclosure relates to a method, apparatus, device, and storage medium for media item generation. The method provided herein includes: displaying a item search page comprising a search control, the item search page being configured to provide an item search result corresponding to received input information; receiving a search term inputted in the search control; providing, in the item search page, a generation entry in association with the search control; and based on a selection of the generation entry, displaying, in the item search page, a set of media items generated based on the search term. In this way, the embodiments of the disclosure may provide users with more diversified media items to meet user specific needs for media items.

### CROSS-REFERENCE

This application claims the priority of Chinese Patent Application No. 202410204985.3, filed on Feb. 23, 2024, entitled “METHOD, APPARTUS, DEVICE AND STORAGE MEDIUM FOR MEDIA ITEM GENERATION,” the entire content of which is incorporated herein by reference.

### FIELD

Example embodiments of the present disclosure generally relate to the field of computers, and in particular, to a method, apparatus, device, and computer-readable storage medium for media item generation.

### BACKGROUND

With the development of computer technology, the Internet has become an important platform for people to create and share content. In the process of sharing the content created by people through the Internet, various media items (e.g., stickers, etc.) have become the personalized expression of people in sharing photos, videos, and other content items. People expect to use more unique and diversified media items in the process of content creation.

### SUMMARY

In a first aspect of the present disclosure, a method of generating media items is provided. The method includes: displaying a item search page including a search control, the item search page being configured to provide an item search result corresponding to received input information; receiving a search term inputted in the search control; providing, in the item search page, a generation entry in association with the search control; and based on a selection of the generation entry, displaying, in the item search page, a set of media items generated based on the search term.

In a second aspect of the present disclosure, an apparatus for media item generation is provided. The apparatus includes: a display module configured to display a item search page including a search control, the item search page being configured to provide an item search result corresponding to received input information; a receiving module configured to receive a search term inputted in the search control; an associating module configured to provide, in the item search page, a generation entry in association with the search control; and a selecting module configured to, based on a selection of the generation entry, display, in the item search page, a set of media items generated based on the search term.

In a third aspect of the present disclosure, an electronic device is provided. The electronic device includes: at least one processing unit; and at least one memory coupled to the at least one processing unit and storing instructions for execution by the at least one processing unit, the instructions, when executed by the at least one processing unit, causing the electronic device to perform the method of the first aspect.

In a fourth aspect of the present disclosure, a computer-readable storage medium having a computer program stored thereon is provided. The computer program being executable by a processor to implement the method of the first aspect.

It should be understood that the content described in this content section is not intended to limit the key features or important features of the embodiments of the present disclosure, nor is it intended to limit the scope of the present disclosure. Other features of the present disclosure will become readily understood from the following description.

### BRIEF DESCRIPTION OF DRAWINGS

The above and other features, advantages, and aspects of various embodiments of the present disclosure will become more apparent from the following detailed description taken in conjunction with the accompanying drawings. In the drawings, the same or similar reference numbers refer to the same or similar elements, wherein:

FIG. 1 illustrates a schematic diagram of an example environment in which embodiments according to the present disclosure may be implemented;

FIG. 2 illustrates an example interface according to some embodiments of the present disclosure;

FIG. 3 illustrates an example interface according to some embodiments of the present disclosure;

FIGS. 4A to 4C illustrate example interfaces according to some embodiments of the present disclosure;

FIG. 5 illustrates an example interface according to some embodiments of the present disclosure;

FIG. 6 illustrates a flowchart of an example process of generating media items according to some embodiments of the present disclosure;

FIG. 7 illustrates a schematic structural block diagram of an example apparatus for media item generation according to some embodiments of the present disclosure; and

FIG. 8 illustrates a block diagram of an electronic device capable of implementing various embodiments of the present disclosure.

### DETAILED DESCRIPTION

Embodiments of the present disclosure will be described in more detail below with reference to the accompanying drawings. While certain embodiments of the present disclosure are shown in the accompanying drawings, it should be understood that the present disclosure may be implemented in various forms and should not be construed as limited to the embodiments set forth herein. Rather, these embodiments are provided for a more thorough and complete understanding of the present disclosure. It should be understood that the drawings and embodiments of the present disclosure are for example purposes only and are not intended to limit the scope of the present disclosure.

It should be noted that the title of any section/subsection provided herein is not limiting. Various embodiments are described throughout, and any type of embodiments may be included in any section/subsection. Furthermore, the embodiments described in any section/subsection may be combined in any manner with the same section/subsection and/or any other embodiment described in different sections/subsections.

In the description of the embodiments of the present disclosure, the terms ‘including’ and the like should be understood to include ‘including but not limited to’. The term ‘based on’ should be understood as ‘based at least in part on’. The terms ‘one embodiment’ or ‘the embodiment’ should be understood as ‘at least one embodiment’. The term ‘some embodiments’ should be understood as ‘at least some embodiments’. Other explicit and implicit definitions may also be included below. The terms ‘first,’ ‘second,’ and the like may refer to different or identical objects. Other explicit and implicit definitions may also be included below.

Embodiments of the present disclosure may relate to data of a user, obtaining and/or use of data, and the like. These aspects all follow the corresponding laws and regulations and related regulations. In the embodiments of the present disclosure, all data collection, acquisition, processing, handling, processing, reposting, use, and the like are carried out on the premise of the knowledge and confirmation of the user. Accordingly, when implementing the embodiments of the present disclosure, the types of the data or information that may be involved, the usage scope, the usage scenario, and the like should be notified to the user and obtain the authorization of the user in an appropriate manner according to the relevant laws and regulations. The specific notification and/or authorization manner may vary according to actual situations and application scenarios, and the scope of the present disclosure is not limited in this respect.

According to the solutions in the present specification and the embodiments, for example, personal information processing is involved, processing may be performed on the premise of having a legality basis (for example, obtaining consent of a personal information subject, or necessary for performing a fulfillment contract), and processing only within a specified or agreed range. The user rejects personal information other than necessary information required by the basic function and may not affect the basic function of the user.

In the process of creating and sharing content through the Internet, media items such as a sticker are important elements used by people to create and process content items. However, in traditional content creation, it is difficult for a user to find a media item that meets his or her specific needs during the search for media items, resulting in a lower desire to create and affecting the user experience.

Embodiments of the present disclosure provide a solution for generating media items. According to the solution, an item search page including a search control is displayed, the item search page being configured to provide an item search result corresponding to received input information. Further, a search term is received via the search control. In addition, in the item search page, a generation entry is provided in association with the search control. Accordingly, based on a selection of the generation entry, a set of media items generated based on the search term is displayed in the item search page.

Embodiments of the present disclosure may provide users with more diversified media items to meet their specific needs for media items, and generate media items through more diversified ways to improve the efficiency of obtaining media items.

Various example implementations of this solution are described in detail below in conjunction with the accompanying drawings.

### Example Environment

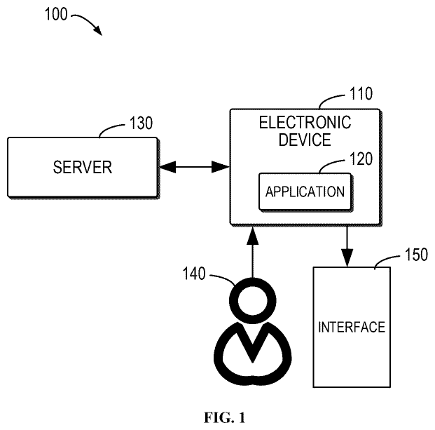

FIG. 1 illustrates a schematic diagram of an example environment 100 in which embodiments of the present disclosure may be implemented. As shown in FIG. 1, the example environment 100 may include an electronic device 110.

In this example environment 100, the electronic device 110 may run an application 120 that supports interface interaction. The application 120 may be any suitable type of application for interface interaction, examples of which may include, but are not limited to: a video application, a social application, or a further suitable application. A user 140 may interact with the application 120 via the electronic device 110 and/or its attachment device.

In the environment 100 of FIG. 1, if the application 120 is active, the electronic device 110 may present, via the application 120, an interface 150 for supporting interface interaction.

In some embodiments, the electronic device 110 communicates with a server 130 to enable provisioning of services to the application 120. The electronic device 110 may be any type of mobile terminal, fixed terminal, or portable terminal, including a mobile phone, a desktop computer, a laptop computer, a notebook computer, a netbook computer, a tablet computer, a media computer, a multimedia tablet, a palmtop computer, a portable game terminal, a VR/AR device, a personal communication system (PCS) device, a personal navigation device, a personal digital assistant (PDA), an audio/video player, a digital camera/camcorder, a positioning device, a television receiver, a radio broadcast receiver, an electronic book device, a gaming device, or any combination of the foregoing, including accessories and peripherals of these devices, or any combination thereof. In some embodiments, the electronic device 110 may also support any type of interface for a user (such as a ‘wearable’ circuit, etc.).

The server 130 may be a standalone physical server, a server cluster composed of a plurality of physical servers, or a distributed system, or may be a cloud server that provides basic cloud computing services such as cloud services, cloud databases, cloud computing, cloud functions, cloud storage, network services, cloud communications, middleware services, domain name services, security services, content distribution networks, and big data and artificial intelligence platforms. The server 130 may include, for example, a computing system/server, such as a mainframe, an edge computing node, a computing device in a cloud environment, or the like. The server 130 may provide background services for the application 120 that support virtual scenarios in the electronic device 110.

A communication connection may be established between the server 130 and the electronic device 110. The communication connection may be established in a wired manner or a wireless manner. The communication connection may include, but is not limited to, a Bluetooth connection, a mobile network connection, a Universal Serial Bus (USB) connection, a Wireless Fidelity (WiFi) connection, and the like. The embodiments of the present disclosure are not limited in this aspect. In the embodiments of the present disclosure, the server 130 and the electronic device 110 may implement signaling interaction through a communication connection between the server 130 and the electronic device 110.

It should be understood that the structures and functions of the various elements in the environment 100 are described for example purposes only and do not imply any limitation to the scope of the present disclosure.

Some example embodiments of the present disclosure will be described below with continued reference to the accompanying drawings.

### Example Interaction

An example interaction process according to embodiments of the present disclosure will be described below with reference to the accompanying drawings.

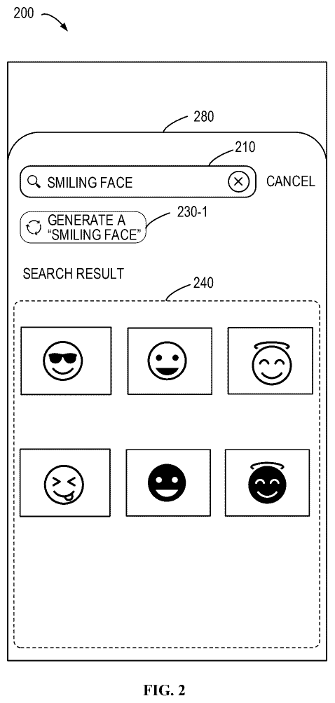

FIG. 2 illustrates an example interface 200 according to some embodiments of the present disclosure. The interface 200 may be provided by the electronic device 110 shown in FIG. 1.

As an example, the interface 200 may be a media editing interface for editing media contents. The electronic device 110 may present an item search page 280 in the interface 200 based on a request by the user to add a media item. The item search page 280 may be an independent interface, a window, a panel, or a specific display area in the interface.

It should be understood that FIG. 2 takes a sticker as an example of a media item, but the media item may further include a further media item with a visual content, including but not limited to a static picture, a dynamic picture, an artistic word, an emoticon item, and the like.

As shown in FIG. 2, after receiving a predetermined operation of the user, the electronic device 110 may invoke the item search page 280 in the interface 200. As shown in FIG. 2, in the item search page 280, the electronic device 110 may provide a search control 210. The search control 210 may be, for example, any suitable type of control for inputting information and providing a media item search function based on the input information. The item search page 280 is configured to provide an item search result corresponding to the received input information.

The search control 210 may receive input information input by a user. The input information may be a description of a sticker that the user desires to add on the media content item. The input information may include a noun representing a person or an object, a verb representing a person or an object related action, an adjective, and the like. The input information may be, for example, ‘a cat is drinking’, ‘a lovely dog’, ‘a little girl twirling in a dress’, etc., to meet a specific expression of the user for the media content item.

The following specific embodiments further describe example processes of the present disclosure with examples in which the input information is ‘smiling face’.

As shown in FIG. 2, in the item search page 280, the electronic device 110 may receive input information input by a user in the search control 210, for example, a search term ‘smiling face’ input by a user is received. Further, the electronic device 110 may receive a confirmation of the search term by the user and query a media item matched with the search term from a local media item library or a remote media item library based on the confirmed search term.

In some embodiments, for a confirmation manner of a search term, the electronic device 110 may provide an electronic keyboard presented in the interface 200 for the user to confirm by clicking on a key when receiving input information from the user, or may provide an additional confirmation button in the item search page 280 for the user to confirm by clicking on a button, or may automatically confirm by detecting whether the user ceases to input the information for a duration that exceeds a predetermined threshold.

Further, after the electronic device 110 queries a media item matched with the search term from a local media item library or a remote media item library based on the confirmed search term, the electronic device 110 correspondingly presents the search result in a result display area 240 in the item search page 280.

In some embodiments, a sticker in the result display area 240 may be determined by the electronic device 110 and/or the server 130 based on the input information (e.g., ‘smiling face’). As an example, the electronic device 110 may search a local sticker item or a cloud sticker item matching the input information based on the input information and present the searched 6 stickers in the result display area 240. Correspondingly, the local sticker item is stored in the local media item library, and the cloud sticker item is stored in the remote media item library.

In some embodiments, a generation entry 230-1 associated with the search control 210 may be displayed in the item search page 280. The generation entry 230-1 is configured to present guidance information corresponding to the search term. Further, when receiving the search term input by the user through the search control 210, the electronic device 110 may synchronously present the generation entry 230-1 in association with the search control 210 in the item search page 280. For example, the generation entry 230-1 may be presented in the vicinity of the search control 210, e.g., at a lower position.

The electronic device 110 may trigger a provision of the generation entry 230-1 when it detects the presence of a character in the search control 210. In the case of Chinese characters, for example, the electronic device 110 may trigger a provision of the generation entry 230-1 when it detects the presence of a character “smile” in the search control 210. In the case of English characters, for example, assuming that the user wants to enter “smiling face” into the search control 210, the electronic device 110 may trigger the provision of the generation entry 230-1 when the electronic device 110 detects the presence of an “s” in the search control 210.

In some embodiments, the guidance information presented in the generation entry 230-1 may be updated as the search term changes. Taking FIG. 2 as an example, the guidance information presented in the generation entry 230-1 includes the text content ‘smiling face’, which is the same as the ‘smiling face’ input by the user in the search control 210. For a further example, assuming that the search term input by the user received in the search control 210 is ‘a cat is drinking’, the guidance information presented in the generation entry 230-1 may include the text content ‘a cat is drinking’.

In some embodiments, the guidance information may also be a text content generated based on the search term and suitable for guiding a model generation item. For example, the search term input by the user may be converted into a text content in the guidance information in an appropriate manner.

In a further embodiment, the electronic device 110 and/or the server 130 may determine whether the search term in the search control 210 is related to a risk condition. If the search term is related to the risk condition, the electronic device 110 and/or the server 130 may change the text content in the guidance information presented in the generation entry 230-1 to information that matches the search term and does not have a relationship to the risk condition. If the search term does not correspond to a risk condition, the text content in the guidance information presented in the generation entry 230-1 is consistent with the search term in the search control 210.

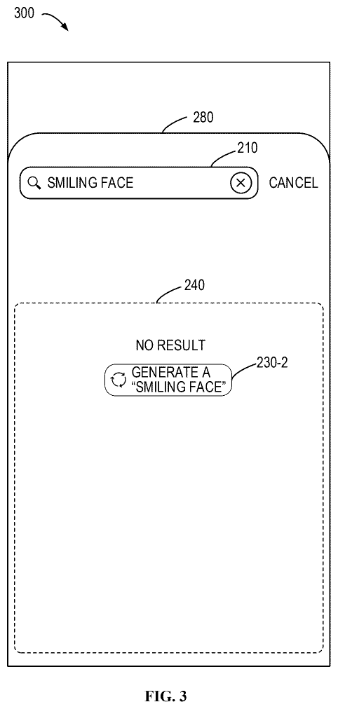

An example interaction process will be described further below with reference to FIG. 3. FIG. 3 illustrates an example interface 300 according to some embodiments of the present disclosure. The interface 300 may be provided by the electronic device 110 shown in FIG. 1.

In an embodiment, after receiving a request for searching for a media item based on the search term, if a number of media items matching the search word is less than a threshold is detected, the electronic device 110 provides the generation entry in the result display area 240 in the item search page 280.

As shown in FIG. 3, when a request for searching for a media item based on the search term is received, if the electronic device 110 does not query a search result in both the local media item library and the remote media item library based on the request, a ‘no result’ typeface may be displayed in the result display area 240. Further, since a number of media items matching the search word is less than a threshold (e.g., 1), the electronic device 110 may also provide accordingly, in the result display area 240, a generation entry 230-2 in association with the search control 210.

Similar to the presentation guidance information in the generation entry 230-1 discussed above, the guidance information presented by the generation entry 230-2 may include a search term, or a further suitable textual content generated based on the search term.

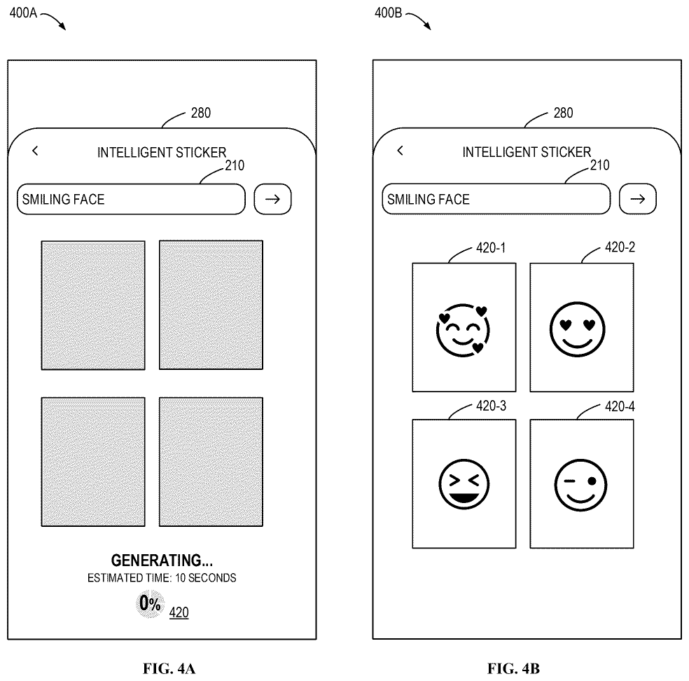

Example interaction processes will be described further below with reference to FIGS. 4A to 4C. FIGS. 4A to 4C illustrate example interfaces 400A to 400B according to some embodiments of the present disclosure. The interfaces 400A to 400C may be provided by the electronic device 110 shown in FIG. 1.

As an example, the interfaces 400A to 400C may be media editing interfaces for editing media contents. The electronic device 110 may present the interface 400A based on a user selection of a generation entry (e.g., the generation entry 230-1 or the generation entry 230-2 discussed above).

It should be understood that the electronic device 110 may provide only one of the generation entry 230-1 and the generation entry 230-2 discussed above when a timing is satisfied accordingly.

Alternatively, the electronic device 110 may also provide the generation entry 230-1 in a search term input stage and provide the generation entry 230-2 when a number of the search results is less than the threshold.

As shown in FIG. 4A, the electronic device 110 may present, in the item search page 280, a process of performing media item generation based on the search term. Specifically, the electronic device 110 may display the generation progress through an icon 420.

In some embodiments, a number of generated media items displayed on the item search page 280 may be limited within a predetermined threshold. For example, the number of media items displayed on the item search page 280 may be set to 4.

As shown in FIG. 4B, the electronic device 110 may display, in the item search page 280, a set of media items generated based on the search term. Taking FIG. 4B as an example, the set of media items may include a plurality of stickers, including sticker 420-1, sticker 420-2, sticker 420-3, and sticker 420-4 (individually or collectively referred to as stickers 420). It should be understood that such stickers are merely examples of media items, and the media items may also include other suitable media items with visual content, such as still images, dynamic pictures, videos, art words, expressions, and the like.

In some further embodiments, the media item (e.g., the sticker 420) may also be generated with a model. Specifically, the electronic device 110 and/or the server 130 may generate an input content to the model based on the input information and may provide the input content to the model. Further, the electronic device 110 and/or the server 130 may obtain a media item, for example, the sticker 420, generated by the model based on the input content.

In some embodiments, when the display interface 400B is triggered via the generation entry 230-1, the plurality of media items provided by the electronic device 110 in the item search page 280 may include both the media items generated and searched based on the search term. As an example, these two types of media items may have different display styles in the item search page 280.

As shown in FIG. 4C, the electronic device 110 may receive a selection of the sticker 420-2 by the user. Further, the electronic device 110 may add the selected sticker 420-2 to a media editing window 470. For example, the electronic device 110 may add the sticker 420-2 to a user-specified location. As an example, the media editing window 470 of the electronic device 110 may display a media content item added with the sticker 420-2 to present a preview content of the media content item to be edited.

In some embodiments, the electronic device 110 may further support adding a plurality of media items to the media editing window 470. For example, the electronic device 110 may support the user to input new information to obtain a sticker or a further type of media item and may add a corresponding media item to the media editing window 470.

As still a further example, the electronic device 110 may also support, for example, the user selecting a plurality of stickers from the stickers 420 provided by the item search page 280 at a time to add to the media editing window 470.

As an example, the electronic device 110 may support the user obtaining a corresponding set of expression items by describing text and may add a first expression item in the expression item to the media editing window.

In some embodiments, the sticker added on the media content item is a used sticker, and the electronic device 110 stores the used sticker locally. For example, even if the media content item has not been posted, or the media content item is discarded, a sticker that is added to a media content item is a used sticker.

In some embodiments, the used media item, such as a sticker, may be stored in association with a search term (referred to as a first search term). For example, the electronic device 110 may store the sticker 420-2 in association with a keyword ‘smiling face’.

Further, the electronic device 110 may receive a search request associated with a second search term (e.g., ‘smile’). If the second search term matches the first search term, at least one media item associated with the first search term is provided as a search result. It should be understood that the second search term and the first search term may be based on character matching, or may be based on semantic matching, which is not intended to be limited in the present disclosure.

For example, the electronic device 110 may store the used sticker in a local predetermined sticker library and set a second search word matching the first search word for the used sticker. Thus, when the user wants to search again from the sticker library based on the second search word, the search result is obtained, which effectively improves the search efficiency of the user for the reuse sticker.

In a further embodiment, all generated stickers displayed on the item search page 280 are added to a historical generation record for the user to directly search for the generated stickers to use, thereby avoiding regeneration, thereby saving the search time of the user.

In some embodiments, the historical generation record may be a sticker generated in a reverse order based on the generation time.

In some embodiments, the electronic device 110 may also receive a request for the user to post the media content item and post the media content item accordingly. For example, the posted media content item may include media items added via the processes described above, or alternative media items may be added.

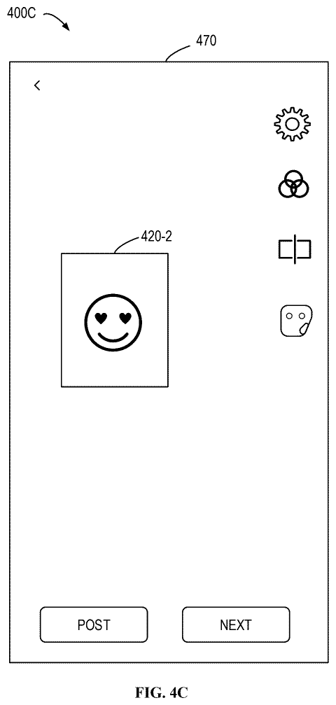

FIG. 5 illustrates an example interface 500 according to some embodiments of the present disclosure. The interface 500 may be, for example, a viewing interface of a posted media content item 510. The interface 500 may be provided by the appropriate electronic device 110, which may be the same as or different from the electronic device 110 used to edit and post the media content item 510.

As shown in FIG. 5, the media content item 510 includes a sticker 520 added based on user input information. In some embodiments, when the sticker 520 is generated based on the input information with the model, the electronic device 110 may further present an indication element 530 in association with the sticker 520 in the viewing interface 500 of the media content item 510, to indicate that the sticker 520 process a sticker generated by the input information of the user with the model.

In some embodiments, the indication element 530 may be configured to be direct to an item generation panel, the item generation panel being configured to provide a media item generated based on received input information. For example, when a browsing user of the media content item 510 is viewing the interface 500, a corresponding client may present the item generation panel based on a selection of the browsing user of the indication element 530.

Specifically, the item generation panel may be configured to present the media item generated based on the received input information, to facilitate the user to add to the media content item.

It should be understood that although the example interaction process is described above by using a sticker as an example, the above interaction process may be applicable to any other suitable media items, for example, a static picture, a dynamic picture, an artistic word, an emoticon item, or the like.

Based on the above process, the embodiments of the present disclosure may provide more diversified media items for the user in the creation process of the media content item, so as to meet the specific requirement of the user for the media item and generate the media item in a more diverse manner, so as to improve the obtaining efficiency of the media item.

### Example Processes

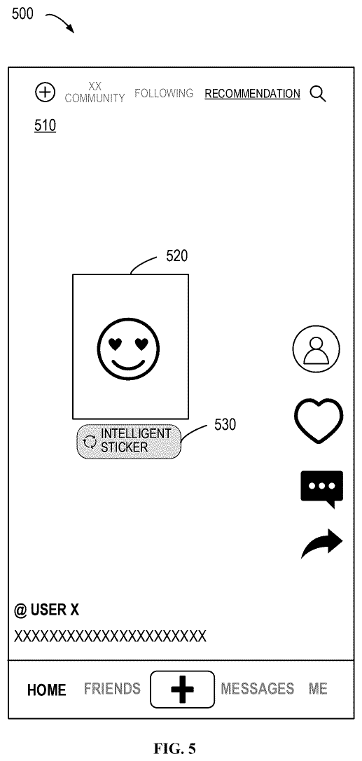

FIG. 6 illustrates a flowchart of an example process 600 of generating media items according to some embodiments of the present disclosure. The process 600 may be implemented at the electronic device 110. The process 600 is described below with reference to FIG. 1.

As shown, at block 610, the electronic device 110 displays a item search page including a search control, the item search page being configured to provide an item search result corresponding to received input information.

At block 620, the electronic device 110 receives a search term inputted in the search control.

At block 630, the electronic device 110 provides, in the item search page, a generation entry in association with the search control.

At block 640, the electronic device 110, based on a selection of the generation entry, displays, in the item search page, a set of media items generated based on the search term.

In some embodiments, wherein providing a generation entry in association with the search control includes: in response to receiving the search term at the search control, providing the generation entry, wherein the generation entry presents first guidance information, wherein the first guidance information is updated as the search word changes.

In some embodiments, wherein providing a generation entry in association with the search control includes: receiving a request of searching for a media item based on the search term; and in response to a number of media items matching the search word being less than a threshold, providing the generation entry in a result display area in the item search page.

In some embodiments, wherein the generation entry presents second guidance information determined based on the search term.

In some embodiments, wherein the set of media items include a first set of media items, and the method further includes: while displaying the first set of media items generated based on the search term, displaying, in the item search page, a second set of media items obtained through a searching using the search term.

In some embodiments, wherein the second set of media items include: a media item matching the search term in a local media item library or a remote media item library.

In some embodiments, the method further includes: based on a selection of at least one of the set of media items, adding the at least one media item in a media editing window.

In some embodiments, the method further includes: storing the at least one added media item in association with the search term.

In some embodiments, wherein the search term is a first search word, and the method further includes: receiving a search request associated with a second search term; and in response to the second search term matching the first search term, providing the at least one media item stored in association with the first search term as a search result.

In some embodiments, the method further includes: posting a media content item based on the at least one media item added in the media editing window.

In some embodiments, wherein a playback interface of the media content item is configured to present an indication element in association with the at least one media item, the indication element being configured to direct to an item generation panel, the item generation panel being configured to provide a media item generated based on received input information.

In some embodiments, wherein the set of media items are generated through: generating an input content to a model based on the search term; and obtaining the set of media items generated by the model based on the input content.

### Example Apparatus and Apparatus

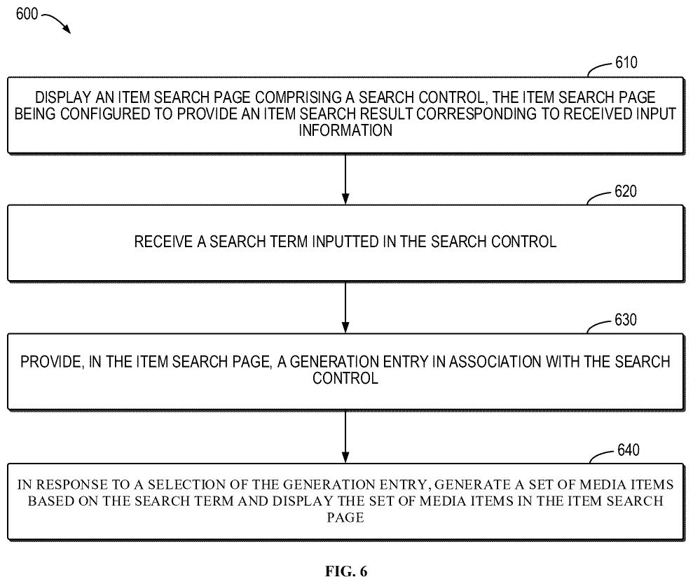

The embodiments of the present disclosure also provide a corresponding apparatus for implementing the above method or process. FIG. 7 illustrates a schematic structural block diagram of an apparatus 700 for media item generation according to some embodiments of the present disclosure. The apparatus 700 may be implemented or included in the electronic device 110. The various modules/components in the apparatus 700 may be implemented by hardware, software, firmware, or any combination thereof.

As shown in FIG. 7, the apparatus 700 includes a display module 710 configured to display a item search page including a search control, the item search page being configured to provide an item search result corresponding to received input information; a receiving module 720 configured to receive a search term inputted in the search control; an associating module 730 configured to provide, in the item search page, a generation entry in association with the search control; and a selecting module 740 configured to, based on a selection of the generation entry, display, in the item search page, a set of media items generated based on the search term.

In some embodiments, the associating module 730 is further configured to: in response to receiving the search term at the search control, provide the generation entry, wherein the generation entry presents first guidance information, wherein the first guidance information is updated as the search word changes.

In some embodiments, the associating module 730 is further configured to: receive a request of searching for a media item based on the search term; and in response to a number of media items matching the search word being less than a threshold, provide the generation entry in a result display area in the item search page.

In some embodiments, the generation entry presents second guidance information determined based on the search term.

In some embodiments, the set of media items include a first set of media items, and the apparatus 700 further includes a simultaneous display module configured to, while displaying the first set of media items generated based on the search term, display, in the item search page, a second set of media items obtained through a searching using the search term.

In some embodiments, the second set of media items include: a media item matching the search term in a local media item library or a remote media item library.

In some embodiments, the apparatus 700 further includes an adding module configured to: based on a selection of at least one of the set of media items, add the at least one media item in a media editing window.

In some embodiments, the apparatus 700 further includes an association storing module configured to: store the at least one added media item in association with the search term.

In some embodiments, the search term is a first search word, and the apparatus 700 further includes a search result module configured to: receive a search request associated with a second search term; and in response to the second search term matching the first search term, provide the at least one media item stored in association with the first search term as a search result.

In some embodiments, the apparatus 700 further includes a posting module configured to: post a media content item based on the at least one media item added in the media editing window.

In some embodiments, a playback interface of the media content item is configured to present an indication element in association with the at least one media item, the indication element being configured to direct to an item generation panel, the item generation panel being configured to provide a media item generated based on received input information.

In some embodiments, the apparatus 700 further includes a generating module configured to: generate an input content to a model based on the search term; and obtain the set of media items generated by the model based on the input content.

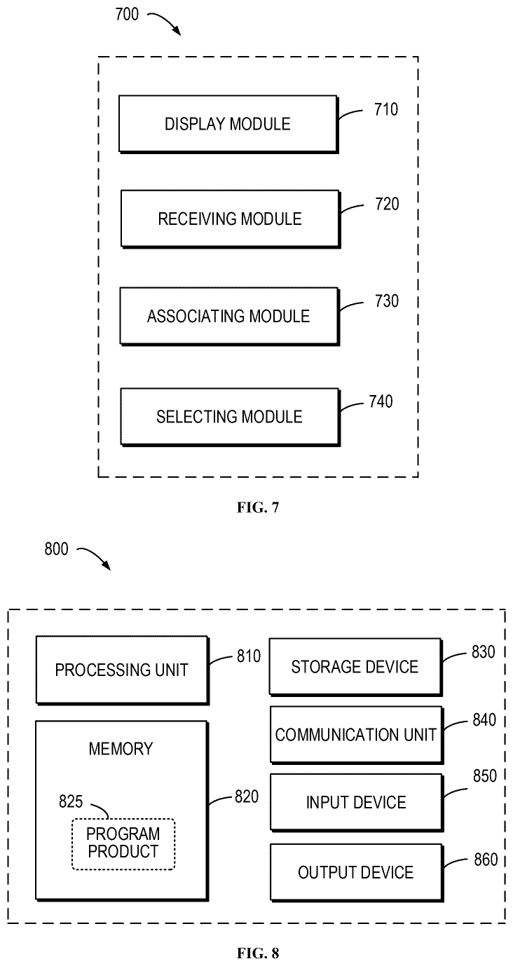

FIG. 8 illustrates a block diagram of an electronic device 800 in which one or more embodiments of the present disclosure may be implemented. It should be understood that the electronic device 800 illustrated in FIG. 8 is merely for example and should not constitute any limitation on the function and scope of the embodiments described herein. The electronic device 800 illustrated in FIG. 8 may be configured to implement the electronic device 110 of FIG. 1.

As shown in FIG. 8, the electronic device 800 is in a form of a general-purpose electronic device. Components of the electronic device 800 may include, but are not limited to, one or more processors or processing units 810, memory 820, storage device 830, one or more communication units 840, one or more input devices 850, and one or more output devices 860. The processing units 810 may be actual or virtual processors and are capable of performing various processes based on programs stored in the memory 820. In a multiprocessor system, a plurality of processing units performs computer-executable instructions in parallel to increase the parallel processing power of the electronic device 800.

The electronic device 800 typically includes a plurality of computer storage media. Such media may be any obtainable media accessible to the electronic device 800, including, but not limited to, volatile and non-volatile media, removable and non-removable media. The memory 820 may be volatile memory (e.g., registers, cache, random access memory (RAM)), non-volatile memory (e.g., read-only memory (ROM), electrically erasable programmable read-only memory (EEPROM), flash memory), or some combination thereof. The storage device 830 may be a removable or non-removable medium and may include a machine-readable medium, such as a flash drive, a disk, or any other medium that may be capable of being configured to store information and/or data and may be accessible within the electronic device 800.

The electronic device 800 may further include additional removable/non-removable, volatile/non-volatile storage media. Although not shown in FIG. 8, a disk drive for reading from or writing to a removable, non-volatile disk (e.g., a ‘floppy disk’) and an optical disk drive for reading from or writing to a removable, non-volatile optical disk may be provided. In these embodiments, each drive may be connected to a bus (not shown) by one or more data media interfaces. The memory 820 may include a computer program product 825 having one or more program modules that are configured to perform various methods or actions of various embodiments of the present disclosure.

The communication unit 840 implements communication with other electronic devices via a communication medium. Additionally, the functions of the components of the electronic device 800 may be implemented as a single computing cluster or a plurality of computing machines that are capable of communicating over a communication connection. Thus, the electronic device 800 may use logical connections to one or more other servers, networked personal computers (PCs), or another network node to operate in a networked environment.

The input device 850 may be one or more input devices, such as a mouse, a keyboard, a tracking ball, and the like. The output device 860 may be one or more output devices, such as a monitor, a speaker, a printer, and the like. The electronic device 800 may also communicate, as desired, via the communication unit 840, with one or more external devices (not shown), external devices such as storage devices, display devices, etc., with one or more devices that enable a user to interact with the electronic device 800, or with any device that enables the electronic device 800 to communicate with one or more other electronic devices (e.g., a network card, modem, etc.) to communicate. Such communication may be performed via an input/output (I/O) interface (not shown).

According to an example implementation of the present disclosure, there is provided a computer-readable storage medium having computer-executable instructions stored thereon, wherein the computer-executable instructions are performed by a processor to implement the method described above. According to an example implementation of the present disclosure, there is also provided a computer program product, the computer program product being tangibly stored on a non-transient computer-readable medium and including computer-executable instructions, wherein the computer-executable instructions are performed by a processor to implement the methods described above.

Aspects of the present disclosure are described herein with reference to flowcharts and/or block diagrams of methods, apparatuses, devices, and computer program products implemented in accordance with the present disclosure. It should be understood that each block of the flowchart and/or block diagram, and combinations of blocks in the flowcharts and/or block diagrams, may be implemented by computer readable program instructions.

These computer-readable program instructions may be provided to a processing unit of a general purpose computer, special purpose computer, or other programmable data processing apparatus to produce a machine, such that the instructions, when executed by a processing unit of a computer or other programmable data processing apparatus, produce means to implement the functions/acts specified in the flowchart and/or block diagram. These computer-readable program instructions may also be stored in a computer-readable storage medium that cause the computer, programmable data processing apparatus, and/or other devices to function in a particular manner, such that the computer-readable medium storing instructions includes an article of manufacture including instructions to implement aspects of the functions/acts specified in the flowchart and/or block diagram(s).

The computer-readable program instructions may be loaded onto a computer, other programmable data processing apparatus, or other apparatus, such that a series of operational steps are performed on a computer, other programmable data processing apparatus, or other apparatus to produce a computer-implemented process such that the instructions executed on a computer, other programmable data processing apparatus, or other apparatus implement the functions/acts specified in the flowchart and/or block diagram block or blocks.

The flowchart and block diagrams in the figures show architecture, function, and operation of possible implementations of systems, methods, and computer program products according to various implementations of the present disclosure. In this regard, each block in the flowchart or block diagram may represent a module, program segment, or part of an instruction that includes one or more executable instructions for implementing the specified logical function. In some alternative implementations, the functions noted in the blocks may also occur in a different order than noted in the figures. For example, two consecutive blocks may actually be performed substantially in parallel, which may sometimes be performed in the reverse order, depending on the function involved. It is also noted that each block in the block diagrams and/or flowchart, as well as combinations of blocks in the block diagrams and/or flowchart, may be implemented with a dedicated hardware-based system that performs the specified functions or actions, or may be implemented in a combination of dedicated hardware and computer instructions.

Various implementations of the present disclosure have been described above, which are exemplary, not exhaustive, and are not limited to the implementations disclosed. Many modifications and variations will be apparent to those of ordinary skill in the art without departing from the scope and spirit of the various implementations illustrated. The selection of the terms used herein is intended to best explain the principles of the implementations, practical applications, or improvements to techniques in the marketplace, or to enable others of ordinary skill in the art to understand the various implementations disclosed herein.

What is claimed is:

1. A method of generating media items, comprising:
displaying an item search page comprising a search control, the item search page being configured to provide an item search result corresponding to received input information;
receiving a search term inputted in the search control;
providing, in the item search page, a generation entry in association with the search control; and
in response to a selection of the generation entry, generating a set of media items based on the search term and displaying the set of media items in the item search page.

2. The method of claim 1, wherein providing the generation entry in association with the search control comprises:
in response to receiving the search term at the search control, providing the generation entry, wherein the generation entry presents first guidance information, wherein the first guidance information is updated as the search word changes.

3. The method of claim 1, wherein providing the generation entry in association with the search control comprises:
receiving a request of searching for a media item based on the search term; and
in response to the number of media items matching the search word being less than a threshold, providing the generation entry in the item search page.

4. The method of claim 3, wherein the generation entry presents second guidance information determined based on the search term.

5. The method of claim 1, wherein the set of media items comprise a first set of media items, and the method further comprises:
displaying the first set of media items generated based on the search term and a second set of media items obtained through a searching using the search term in the item search page,.

6. The method of claim 5, wherein the second set of media items comprise: a media item matching the search term in a local media item library or a remote media item library.

7. The method of claim 1, further comprising:
based on a selection of at least one of the set of media items, adding the at least one media item in a media editing window.

8. The method of claim 7, further comprising:
storing the at least one added media item in association with the search term.

9. The method of claim 8, wherein the search term is a first search word, and the method further comprises:
receiving a search request associated with a second search term; and
in response to the second search term matching the first search term, providing the at least one media item stored in association with the first search term as a search result.

10. The method of claim 7, further comprising:
posting a media content item based on the at least one media item added in the media editing window.

11. The method of claim 10, wherein a playback interface of the media content item is configured to present an indication element in association with the at least one media item, the indication element being configured to direct to an item generation panel, the item generation panel being configured to provide a media item generated based on the received input information.

12. The method of claim 1, wherein the set of media items are generated through:
generating an input content to a model based on the search term; and
obtaining the set of media items generated by the model based on the input content.

13. An electronic device comprises:
at least one processing unit; and
at least one memory coupled to the at least one processing unit and storing instructions for execution by the at least one processing unit, the instructions, when executed by the at least one processing unit, causing the electronic device to perform operations comprising:
displaying a item search page comprising a search control, the item search page being configured to provide an item search result corresponding to received input information;
receiving a search term inputted in the search control;
providing, in the item search page, a generation entry in association with the search control; and
based on a selection of the generation entry, displaying, in the item search page, a set of media items generated based on the search term.

14. The electronic device of claim 13, wherein providing a generation entry in association with the search control comprises:
in response to receiving the search term at the search control, providing the generation entry, wherein the generation entry presents first guidance information, wherein the first guidance information is updated as the search word changes.

15. The electronic device of claim 13, wherein providing a generation entry in association with the search control comprises:
receiving a request of searching for a media item based on the search term; and
in response to a number of media items matching the search word being less than a threshold, providing the generation entry in a result display area in the item search page.

16. The electronic device of claim 15, wherein the generation entry presents second guidance information determined based on the search term.

17. The electronic device of claim 13, wherein the set of media items comprise a first set of media items, and the method further comprises:
while displaying the first set of media items generated based on the search term, displaying, in the item search page, a second set of media items obtained through a searching using the search term.

18. The electronic device of claim 17, wherein the second set of media items comprise: a media item matching the search term in a local media item library or a remote media item library.

19. The electronic device of claim 13, wherein the operations further comprise:
based on a selection of at least one of the set of media items, adding the at least one media item in a media editing window.

20. A non-transitory computer-readable storage medium having a computer program stored thereon, the computer program being executable by a processor to implement operations comprising:
displaying a item search page comprising a search control, the item search page being configured to provide an item search result corresponding to received input information;
receiving a search term inputted in the search control;
providing, in the item search page, a generation entry in association with the search control; and
based on a selection of the generation entry, displaying, in the item search page, a set of media items generated based on the search term.
